(19) United States
(12) Patent Application Publication
(10) Pub. No.: US 2014/0253673 A1
(43) Pub. Date: Sep. 11, 2014

(54) VIDEO OUTPUT CONVERSION SYSTEM

(71) Applicant: Summit Imaging, Inc., Woodinville, WA (US)

(72) Inventor: Stephenjon Besagar Barredo, Lynnwood, WA (US)

(73) Assignee: Summit Imaging, Inc., Woodinville, WA (US)

(21) Appl. No.: 14/198,073

(22) Filed: Mar. 5, 2014

Related U.S. Application Data
(60) Provisional application No. 61/773,054, filed on Mar. 5, 2013.

(51) Int. Cl. H04N 7/01; H04N 7/15

(52) U.S. Cl. CPC H04N 7/0125; H04N 7/15
USPC 348/14.08; 348/445

(57) ABSTRACT

A device for converting a video signal from one DVI format to another is provided, the device having an input module configured to convert a first DVI video signal to an HDMI video signal, a converter configured to convert the HDMI video signal to a VGA video signal, and an output module configured to convert the VGA video signal to a second DVI video signal. A medical teleconferencing system is also provided, the system having a video imaging device that outputs a video signal in a first DVI format, a video conferencing system configured to receive a video signal in a second DVI format, and a conversion device configured to receive the video signal in the first DVI format, convert the video signal in the first DVI format to a HDMI video signal, convert the HDMI video signal to a VGA video signal, and convert the VGA video signal to a video signal in the second DVI format for output to the video conferencing system.

### BACKGROUND

1. Technical Field

The present disclosure pertains to the transmission of video signals and, more particularly, to a video signal compatibility system that enables hardwired reception and processing of video output signals that are incompatible with the receiving equipment.

2. Description of the Related Art

Compatibility between video processing equipment, such as a video imaging system and a teleconference communication system, enables reception and processing of video signals generated by the video imaging system. Issues arise when the video output signal is generated according to one standard and the receiving equipment is configured to accept only video signals generated by another standard or when incompatible connectors and cables are used. For example, if a device that is not compatible with the HDCP (high-bandwidth digital content protection) standard is connected with an HDMI cable to a system that uses the HDCP standard, the video or audio that is output from the system cannot be processed by the device.

Another example is copyright-protected content, such as that found on a Blu-ray disc, which can only be output at 1080p when using an HDMI cable connected to a device that is compatible with the HDCP standard. A further example is when the PS3 gaming system is connected to a television or a monitor using a D-terminal cable, a component AV cable, or a multi-AV cable and analog high-definition output is restricted in order to comply with the copyright protection technology used by Blu-ray (AACS).

Recently, the enhanced ability of teleconferencing has given a rise to “telemedicine.” This is the use of medical information transmitted between healthcare providers or treatment sites using electronic communications. “Telehealth” is related to telemedicine in that it pertains to remote health care, with or without clinical services. Telemedicine and telehealth rely on the use of video output signals for video conferencing, transmission of still images, document sharing, monitoring of vital signs remotely, and providing access to medical records.

However, one impediment to this growing use of technology is the incompatibility of the video signals or the equipment, such as a video imaging machine and the video conferencing system used by participants to view the video images generated by the video imaging system at remote locations. Hence, there is a need for a video compatibility system that converts a video output signal to a usable video input signal at a video conferencing device.

### BRIEF SUMMARY

The present disclosure is directed to a video conversion system and method that address the foregoing and other issues related to video signal compatibility.

In accordance with one aspect of the present disclosure, a device is provided that includes a converter having an input terminal, an output terminal and a conversion circuit, the converter is configured to receive a video signal in a first format and convert the video signal to a video signal in a second format. In another aspect of the present disclosure, the converter is coupled to an output terminal of an input module that is configured to receive a DVI video signal.

In yet another aspect of the present disclosure, the converter is further coupled to an input terminal of an output module. Ideally, the output module is configured to receive a VGA video signal from the converter and output a DVI video signal, and the converter is configured to receive an HDMI video signal from the input module and convert the HDMI video signal to the VGA video signal.

In accordance to another aspect of the present disclosure , a system is provided that includes a video imaging device that is configured to output a video signal in a first DVI format, a video conferencing system that is configured to receive a video signal in a second DVI format, and a conversion device coupled to the video imaging device and the video conferencing system. The conversion device includes an input module, a converter, and an output module. The input module has an input terminal coupled to the video imaging system and is configured to receive and convert a video signal in the first DVI format from the video imaging system to an HDMI video signal. The converter has an input terminal coupled to the output terminal of the input module and is configured to receive and convert the HDMI video signal from the input module to a VGA video signal. The converter also has an output terminal configured to output the VGA video signal. The output module has an input terminal coupled to the output terminal of the converter and is configured to receive and convert the VGA video signal from the converter to a video signal in the second DVI format. The output module also has an output terminal coupled to the video conferencing system, the output terminal is configured to output the video signal in the second DVI format.

In accordance with another aspect of the present disclosure, a method of video signal conversion is provided. The method includes converting a signal from a video imaging device to a compatible input signal in a video conferencing system, including receive a video input signal in a first DVI format from the video imaging device; converting the video signal in the first DVI format to a HDMI video signal; converting the HDMI video signal to a VGA video signal; and converting the VGA video signal to a video signal in a second DVI format that is compatible as an input signal to the video conferencing system.

In accordance with another aspect of the present method, the converting the video signal in the first DVI format to the HDMI video signal comprises using a dongle to convert the video signal in the first DVI format to the HDMI video signal.

### BRIEF DESCRIPTION OF THE SEVERAL VIEWS OF THE DRAWINGS

FIG. 1 illustrates a typical environment in which an exemplary embodiment of the present disclosure is implemented.

FIG. 2 illustrates an exemplary embodiment of the present disclosure as implemented in a medical teleconferencing setting.

### DETAILED DESCRIPTION

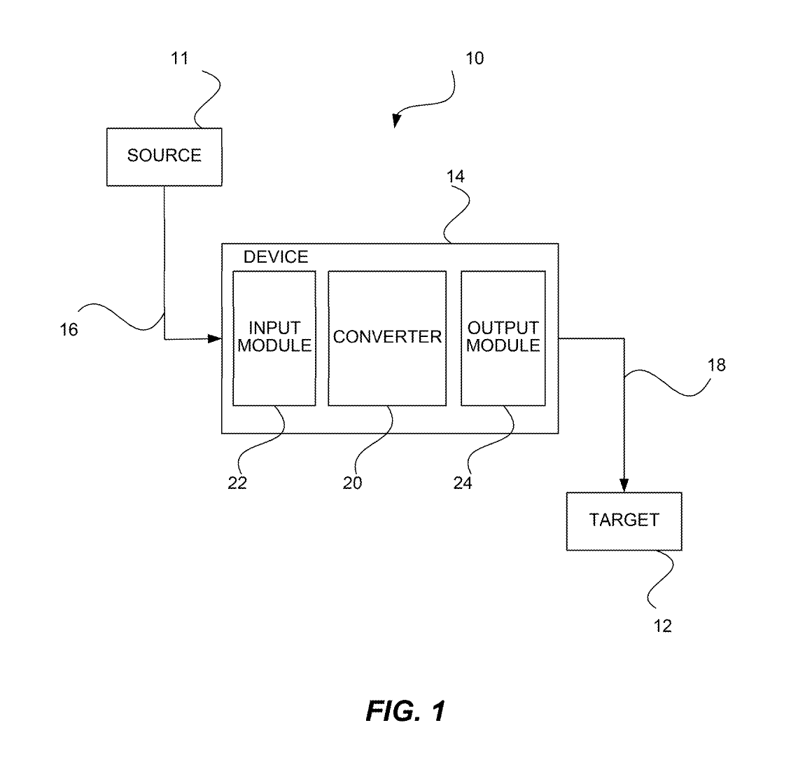

An exemplary embodiment of the present disclosure is illustrated in FIG. 1. In FIG. 1, a typical environment 10 is shown to include a source device 11, a target device 12, and a conversion device 14. The source device 11 is coupled to the conversion device 14 via a first cable 16, and the conversion device 14 is coupled to the target device 12 via a second cable 18.

The source device 11 is configured to output a video signal and an audio signal. The source device 11 may be a computer, a medical monitoring device, or the like. The video signal output by the source device 11 is preferably compliant with the Digital Visual Interface (DVI) standards. It is also contemplated, however, that the source device 11 is configured to output video signal that is compliant with other video transfer standards, such as VGA, HDMI, S-Component or other standards. The first cable 16 is a cable capable of carrying the video signal output by the source device 11 to the target device 12 in an appropriate format, and it is configured to connect to the source device 10 through a physical connector (not shown). The physical connector is preferably a DVI-I connector.

The target device 12 is configured to receive a video signal and an audio signal. The target device 12 is preferably a multimedia collaboration device, such as a video teleconferencing device, that is configured to receive a video signal compliant with the Digital Visual Interface (DVI) standards. The target device 12 may also be a display device, a video/audio device, a projector, or a computer. The target device 12 is further configured to receive the video signal via the second cable 18. The second cable 18 is configured to connect to the target device 12 through a physical connector (not shown). The physical connector is preferably a DVI-I connector.

The conversion device 14 includes an input module 22, an output module 24, and a converter 20. The conversion device 14 is configured to receive a video signal at an input terminal (not shown) and to output a video signal from an output terminal (not shown). In one embodiment, the input terminal and the output terminal each includes a physical connector such as a socket, a plug, a clip, screw terminal and the like . The input module 22 is coupled to the input terminal of the conversion device 14 and is configured to convert a video signal from one video transfer standard to another video transfer standard. Transfer standards for a video signal may be DVI, High Definition Multimedia Interface (HDMI), or Analog (composite video, S-video, component video, or Video Graphic Array). In a preferred embodiment, the input module 22 converts a DVI compliant video signal to a HDMI compliant video signal in accordance with known conversion technology and will not be described in detail herein.

The converter 20 is coupled to the input module 22 and is configured to convert a video signal from one video transfer standard to another video transfer standard. In a preferred embodiment, the converter 20 converts an HDMI compliant video signal to a VGA video signal. A conversion of a video signal from other video transfer standards is also contemplated. In another embodiment, the converter 20 is further configured to convert an audio signal from one video transfer standards to another video transfer standard. An audio signal may be transferred in digital or in analog format, and it is contemplated that the converter 20 converts the audio signal from a digital format to an analog format using known digital to analog conversion techniques.

The output module 24 is coupled to the converter 20 and to the output terminal of the conversion device 14. The output circuit 24 is configured to convert a video signal from one video transfer standard to another video transfer standard. In a preferred embodiment, the output module 24 converts a VGA video signal to a DVI video signal in accordance with known conversion technology and will not be described in detail herein.

The converter 20 is independently provided with electrical power. In a preferred embodiment, the conversion circuit 20 includes a 5V power supply. Power supplies of different voltage levels are also contemplated to provide power to the converter 20.

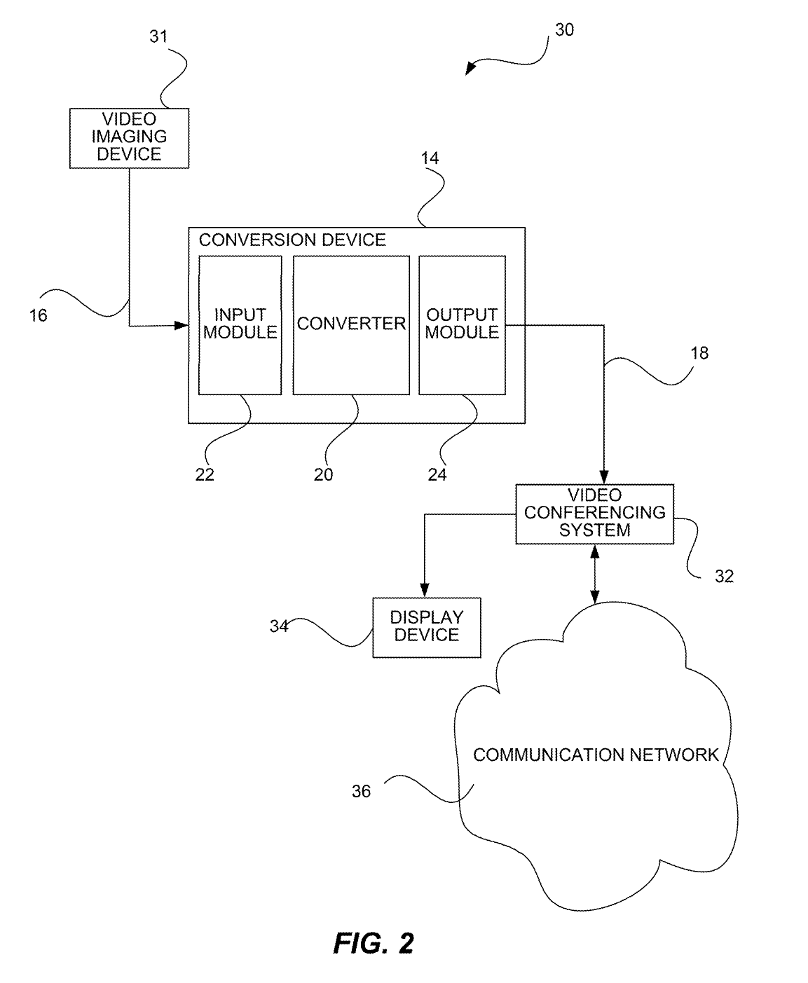

FIG. 2 illustrates a preferred embodiment of the present disclosure. The preferred embodiment in FIG. 2 illustrates a teleconference setting 30 in which an output video from a video imaging device 31 is made available for viewing by attendees of the teleconference with the use of the videoconferencing system 32. This preferred embodiment enables collaboration between attendees.

The preferred embodiment 30 in FIG. 2 includes the video imaging device 31 configured to output a video signal in a first DVI format, the video signal in the first DVI format being a DVI compliant video signal. The video imaging device 31 is preferably an ultrasound machine. Other video imaging devices configured to output a video signal in a first DVI format are also contemplated, such as patient monitoring devices, an MRI machine, a CT machine, or other computing devices. The output video signal in the first DVI format is carried by the first cable 16 to the conversion device 14. The first cable 16 in FIG. 12 is a DVI cable capable of carrying the video signal in the first DVI format.

The conversion device 14 in FIG. 2 includes the input module 22 configured to receive and convert the video signal in the first DVI format into an HDMI video signal. The input module 22 is preferably packaged as a dongle or a device that serves as an adapter. The converter 20 is configured to receive and convert the HDMI video signal output by the input module 22 to a VGA video signal. The converter 20 is further configured to transmit the VGA video signal to the output module 24. The converter 20 is preferably a HDMI to VGA converter device such as a SIIG CE-H20511-S1 device. The output module 24 is configured to receives and converts the VGA video signal from the converter 20 into a video signal in the second DVI format. The output module 24 is further configured to output the video signal in the second DVI format to the video conferencing system 32 via the second cable 18. The second cable 18 in FIG. 2 is configured to carry the video signal in the second DVI format.

The video conferencing system 32 is configured to receive the video signal in the second DVI format, the video signal in the second DVI format being a

DVI compliant video signal. An example of the video conferencing system 32 is a Polycom Video Conferencing system. The video conferencing system 32 in FIG. 2 is coupled to a display device 34, such as a monitor, and to a communication network 36. The video received by the video conferencing system 32 as the video signal of the second DVI format can be further output to the display device 34 and forwarded to the communication network 36 to allow attendees of the teleconference to simultaneously view the video. The communication network 36 may be the internet, a private network, or other computer networks.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a converter having an input terminal, an output terminal, and a conversion circuit configured to receive a video input signal in a first format and to convert the video input signal to a video output signal in a second format wherein the device is configured to receive the video input signal in a first DVI format, convert the video signal in the first DVI format to a HDMI video signal, convert the HDMI video signal to a VGA video signal, and convert the VGA video signal to a video signal in a second DVI format .

2. The circuit of claim 1, further comprising an input module having an input terminal and an output terminal, the input terminal configured to receive the video output signal in the first DVI format and the output terminal configured to be coupled to the input terminal of the converter and to output the HDMI video signal.

3. The circuit of claim 2, further comprising an output module having an input terminal configured to be coupled to the output terminal of the converter and an output terminal, the input terminal configured to receive the VGA video signal from the converter and the output terminal configured to output the second DVI video signal.

4. The circuit of claim 3 wherein the converter is configured to receive the HDMI video signal on the input terminal of the converter and to convert the HDMI video signal to the VGA video signal, and to then output the VGA video signal on the output terminal of the converter.

5. A system, comprising:
a video imaging device configured to output a video signal in a first DVI format;
a video conferencing system configured to receive a video signal in a second DVI format; and
a conversion device that comprises:
an input module having an input terminal coupled to the video imaging device and configured to receive the video signal in the first DVI format, the input module having an output terminal and configured to convert the video signal in the first DVI format to a HDMI video signal and output the HDMI video signal on the output terminal;
a converter having an input terminal coupled to the output terminal of the input module and configured to receive the HDMI video signal, an audio-video conversion circuit configured to convert the HDMI video signal to a VGA video signal, and an output terminal configured to output the VGA video signal; and
an output module comprising an input terminal coupled to the output terminal of the converter , the input terminal configured to receive the VGA video signal, the output module having an output terminal and configured to convert the VGA video signal to the video signal in the second DVI format and to output the video signal in the second DVI format on the output terminal, the output terminal being coupled to the video teleconferencing system.

6. The system of claim 5 wherein the input module is configured as a dongle to convert the video signal in the first DVI format to the HDMI video signal.

7. The system of claim 5 wherein the output module comprises an adapter configured to convert the VGA video signal to the video signal in the second DVI format.

8. The system of claim 5 wherein the audio-video converter circuit comprises at least one of an HDMI to VGA video with audio converter and an HDMI to YPbPr video with audio converter.

9. A method of a converting a signal from a video imaging device to a compatible input signal in a video conferencing system, the method comprising:
receive a video input signal in a first DVI format from the video imaging device;
converting the video signal in the first DVI format to a HDMI video signal;
converting the HDMI video signal to a VGA video signal; and
converting the VGA video signal to a video signal in a second DVI format that is compatible as an input signal to the video conferencing system.

10. The method of claim 9 wherein converting the video signal in the first DVI format to the HDMI video signal comprises using a dongle to convert the video signal in the first DVI format to the HDMI video signal.

11. The method of claim 9 wherein converting the FGA video signal to the video signal in the second DVI format comprises using an adapter configured to convert the VGA video signal to the video signal in the second DVI format.

12. The method of claim 9 wherein converting the HDMI video signal to the VGA signal comprises using at least one of an audio-video converter circuit having an HDMI to VGA video with audio converter and an HDMI to YPbPr video with audio converter.
